(19) United States
(12) Patent Application Publication
(10) Pub. No.: US 2007/0156938 A1
(43) Pub. Date: Jul. 5, 2007

(54) Interconnect structure between HyperTransport bus interface boards

(76) Inventors: Manbo Wu, Shenzhen (CN); Yingdong Huang, Shenzhen (CN); Chao Liu, Shenzhen (CN); Zhenhong Li, Shenzhen (CN)

Correspondence Address: LADAS & PARRY, 5670 WILSHIRE BOULEVARD, SUITE 2100, LOS ANGELES, CA, 90036-5679, US

(21) Appl. No.: 11/647,520

(22) Filed: Dec. 28, 2006

(30) Foreign Application Priority Data
Dec. 28, 2005 (CN) 200520146992.5

(51) Int. Cl. G06F 13/00

(52) U.S. Cl. 710/112

(57) ABSTRACT

An interconnect structure between HyperTransport bus interface boards, for interconnecting corresponding HyperTransport bus interfaces disposed on different Printed Circuit Boards (PCBs) via a connector. The connector cuts across a HyperTransport bus, and terminals of two HyperTransport bus interfaces on different PCBs connected via the connector are connected with each other correspondingly via connecting lines sequentially distributed, so as to avoid the intercross of the connecting lines. The present invention may solve the problem of intercrossing of signals on the HyperTransport bus between processors or other chips during inter-board connecting without the increase of PCB layer number or the degradation of signal quality and the additional cost.

### FIELD OF THE INVENTION

The present invention relates to the technical field of electronic or communication equipment manufacturing, in particular, to an interconnect structure between HyperTransport bus interface boards.

### BACKGROUND OF THE INVENTION

HyperTransport is an end-to-end bus technology designed for the integrated circuit interconnection on a motherboard. It can provide higher data transmission bandwidth between a memory controller, a disk controller and a PCI bus controller. HyperTransport technology helps reduce the number of buses in a system and provide high-performance data transmission scheme for embedded applications. For example, HyperTransport technology may provide a high-level end-to-end internal connection standard to meet the data transmission requirement of a memory and an I/O element, and may be utilized to connect conventional low speed I/O devices and high speed I/O media. HyperTransport technology allows chips inside of PCs, network and communication devices to communicate with a data transmission bandwidth up to several times or even tens of times faster than some existing technologies.

HyperTransport technology has been employed in numerous processors or other chips. HyperTransport is a high speed, differential and point-to-point bus interconnection technology. It has a strict demand on impedance control during the interconnection of Printed Circuit Boards (PCBs), and requires avoiding signals passing through via-holes and avoiding swapping layers to run a wire.

When processors or other chips employing HyperTransport technology on a same plane of a same PCB are HyperTransport interconnected, the connection mode is shown in FIG. 1. FIG. 1 shows the connection mode of two typical HyperTransport devices interconnected on the same Printed Circuit Board (PCB). Each processor has two transmit ports (T×m, T×n) and two receive ports (R×m, R×n). The transmit ports of one processor are connected with the receive ports of the other chip. It is noted that the Pin Designations on the device for the receive signals and transmit signals on the bus are suitable for this interconnection mode very much. When two devices respectively on two PCBs which are separated while still on a same plane are Hypertransport interconnected, the connection mode is shown in FIG. 2A and FIG. 2B. Each processor has two transmit ports (T×m, T×n) and two receive ports (R×m, R×n). The positions of the transmit ports and the receive ports of the two processors are opposite to each other, and the transmit ports of one processor are connected to the receive ports of the other chip via a connector. It is easy for the connector to realize the above interconnection mode of the two HyperTransport devices on PCBs which are separated while still on the same plane. In view of the convenience for the signal pin distribution design of the device, a PCB designer may easily realize the signal connection by using four or less layers.

It can be seen from the above two schemes that the receive signals and transmit signals, the clock signals and the control signals of a Hypertransport bus interface are all sequentially distributed from left to right and receive/transmit pairs are formed up and down, so no problem of signal intercrossing will occur.

FIG. 3A and FIG. 3B illustrate the front view and the side view of a interconnect structure of HyperTransport bus interfaces of two PCBs on different planes in the prior art. As shown in FIG. 3A and FIG. 3B, it is the interconnection mode for two HyperTransport devices of two PCBs disposed on different planes. Each processor has two transmit ports (T×m, T×n) and two receive ports (R×m, R×n). The orientations of the transmit ports and the receive ports of one processor are the same with those of the other processor respectively, and the transmit ports of one processor are connected with the receive ports of the other chip via a connector. It can be seen that the Pin Designations on the device for the receive and transmit signals on the bus hinder the interconnection of the devices, and the signals on the bus have to intercross for one time so as to realize a proper interconnection between the devices. When the processors or other chips are not on a same PCB but on two different PCBs and the two PCBs are not on a same plane, a board-to-board connector is needed to realize the HyperTransport interconnection. In a certain case, such an interconnection will cause the intercrossing of the signals on the bus.

As shown in FIG. 3A and FIG. 3B, processor Chip0 is disposed on a lower PCB and processor Chip1 is disposed on an upper PCB. As shown in FIG. 4, Chip00, Chip01, Chip02 and Chip03 on two PCBs disposed in different planes are interconnected via Hypertransport bus interfaces, which is a supplement of the interconnect structure of Hypertransport bus interfaces shown in FIG. 3. Such an interconnection is very difficult for the design of an inter-board connector. It can be seen that the receive signals, the transmit signals and other signals such as clock signals and control signals intercross during the interconnection. Such an intercrossing problem is caused by the positions of the devices, the distribution of encapsulation pins of the devices and the PCB connection mode. Those signals may be interconnected via cross-connected connectors, which is difficult or impossible to realize physically.

Such a signal intercrossing problem may be generally solved by passing signals through via-holes on PCBs to swap layers to run wires. However, such a scheme is inhibited for a HyperTransport bus. Another solution is to increase the number of PCB layers such that no signal intercrossing will occur without swapping layers to run wires; but this solution causes the number of PCB layers and the cost to increase in times; meanwhile it is difficult to realize the PCB processing.

When more than one HyperTransport bus is disposed between the two PCBs, such an intercrossing will become more severe. It can be seen that the degradation of signal quality and the additional cost will be caused in the process of solving the signal intercrossing problem in the prior art.

### SUMMARY OF THE INVENTION

Some embodiments of the present invention provide an interconnect structure between HyperTransport bus interface boards, such that signals on a HyperTransport bus between processors or other chips may not intercross with each other during the interconnection between the boards without increasing the number of PCB layers.

In the interconnect structure between HyperTransport bus interface boards, for interconnecting corresponding HyperTransport bus interfaces disposed on two different Printed Circuit Boards (PCBs) through a connector, the connector cuts across a HyperTransport buses, and terminals of two HyperTransport bus interfaces on different PCBs connected via the connector are connected with each other correspondingly via connecting lines sequentially distributed, to avoid the intercross of signals on a HyperTransport bus.

The embodiments of the present invention provides an interconnect structure between HyperTransport boards, which is adapted for interconnecting the corresponding HyperTransport bus interfaces disposed on different Printed Circuit Boards (PCBs) via a connector; it is different from the prior art in that the connector according to the embodiments of the present invention cuts across the HyperTransport bus. Thus, a HyperTransport interconnection between boards is achieved without intercrossing. The structure according to the embodiments of the present invention may solve the problem of intercrossing of signals on a HyperTransport bus between processors or other chips during inter-board connecting without the increase of PCB layer number or the degradation of signal quality and the additional cost.

### BRIEF DESCRIPTION OF THE DRAWINGS

FIG. 1 shows a schematic diagram of a HyperTransport interconnect structure on a same plane of a same PCB in the prior art;

FIG. 2A and FIG. 2B are respectively the front view and the side view of a HyperTransport interconnect structure of two separated PCBs on a same plane in the prior art;

FIG. 3A and FIG. 3B show the front view and the side view of a HyperTransport interconnect structure of two PCBs on different planes in the prior art;

FIG. 4 shows a schematic diagram of chips disposed on two PCBs in different planes which need to be connected via HyperTransport;

FIG. 5A and FIG. 5B are respectively the front view and the side view of an exemplary interconnect structure of HyperTransport boards according to an embodiment of the present invention;

FIG. 6 shows a schematic diagram of a connection structure of HyperTransport chips on two PCBs in different planes according to an embodiment of the present invention;

FIG. 7A and FIG. 7B are respectively the front view and the side view of an interconnect structure of HyperTransport boards according to the embodiment shown in FIG. 6.

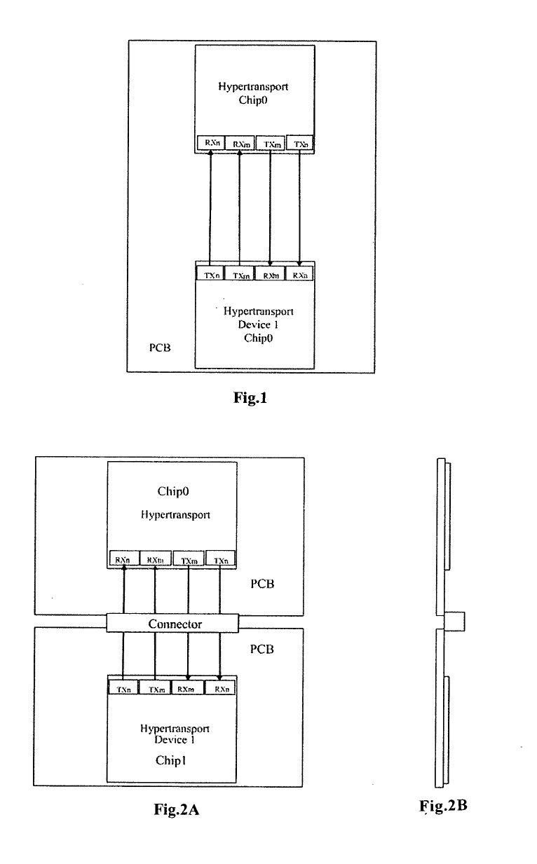

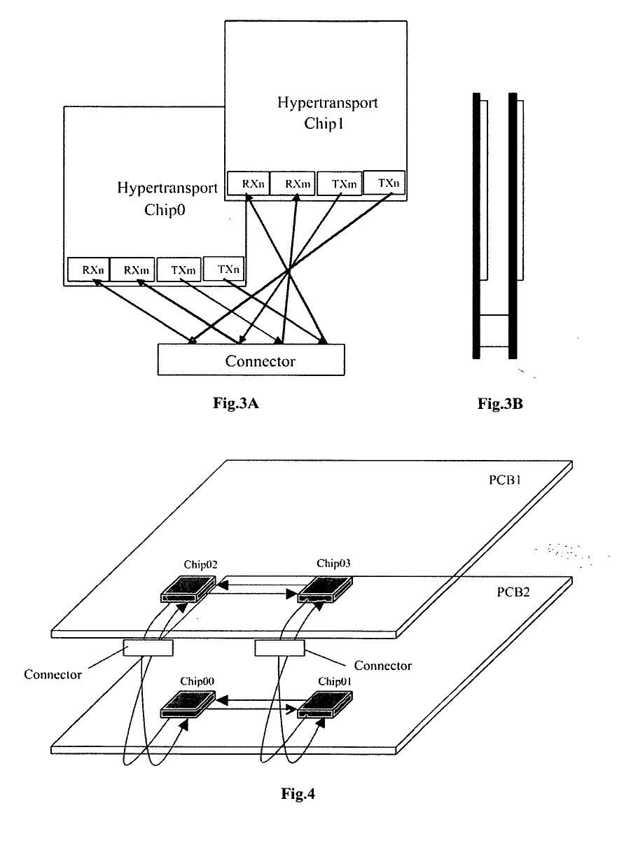

### DETAILED DESCRIPTION OF THE EMBODIMENTS

The structure and features of the present invention will become more apparent by the following description in detail with reference to the embodiments and the accompanying drawings.

According to the interconnect structure between HyperTransport bus interface boards of an embodiment of the invention, the corresponding HyperTransport bus interfaces disposed on different PCBs are interconnected via a connector; it is different from the prior art in that the connector according to the embodiments of the present invention cuts across the HyperTransport bus. Thus, the signals on the HyperTransport bus between the PCBs will not intercross.

It is noted that in practice one or multiple connectors may be utilized.

When multiple connectors are used, the multiple connectors may be arranged in the following three modes:

(1) The multiple connectors are disposed collinearly in the longitudinal direction of the connectors;

(2) The multiple connectors are disposed in parallel in the longitudinal direction of the connectors; or

(3) The multiple connectors are disposed to be interleaved.

In practice, there are one or multiple pairs of HyperTransport bus interfaces corresponding to the multiple connectors, which are interconnected via the corresponding connectors respectively.

When there are more than one pair of HyperTransport bus interfaces, the more than one pair of HyperTransport bus interfaces may be disposed in the following three modes:

(a) The more than one pair of HyperTransport bus interfaces are disposed collinearly in the interface arrangement direction on the two PCBs respectively;

(b) The more than one pair of HyperTransport bus interfaces are disposed in parallel in the interface arrangement direction on the two PCBs respectively; and

(c) The more than one pair of HyperTransport bus interfaces are disposed to be interleaved on the two PCBs.

It is noted that in practice there may be the following corresponding modes of the connectors and the HyperTransport bus interfaces:

One connector corresponds to a pair of HyperTransport bus interfaces;

One connector corresponds to multiple pairs of HyperTransport bus interfaces; or

Multiple connectors correspond to a pair of HyperTransport bus interfaces.

In conjunction with the above discussion, the embodiments of the present invention are described hereunder.

FIG. 5A and FIG. 5B are respectively the front view and the side view of an exemplary structure of an interconnection device between HyperTransport bus interface boards according to an embodiment of the invention.

FIG. 5A and FIG. 5B show one connector and a pair of HyperTransport bus interfaces corresponding to the connector. It can be seen from FIG. 5A and FIG. 5B that the connector cuts across the HyperTransport bus, that is, a transmit interface of one processor is connected with a receive port of another chip through the connector, and the connecting lines between the two processors are connected sequentially to the connector. As a result, a HyperTransport bus interconnection between the PCBs is achieved without signal intercrossing. By use of the connector design shown in FIG. 5, device interconnection may be achieved without intercross occurring on the connecting lines of the bus.

When multiple connectors and multiple pairs of HyperTransport bus interfaces corresponding to the multiple connectors are disposed between the two PCBs, the advantages of the above connection mode will become more apparent.

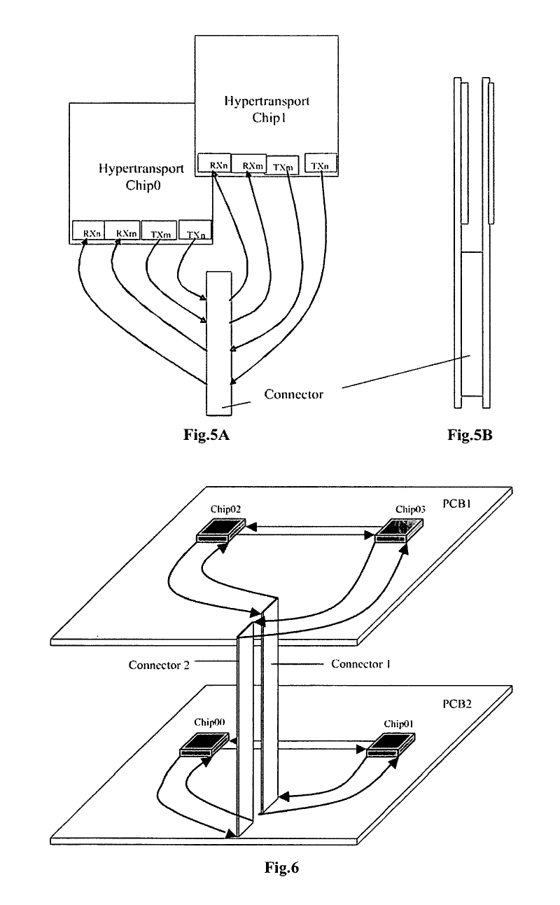

The interconnect structure shown in FIG. 6 is an expansion of the connection structure shown in FIG. 5. Four devices/equipments may be interconnected in this way, and the interconnection space may be utilized to a maximum extent.

Referring to FIG. 6, according to an embodiment of the present invention, Chip00, Chip01, Chip02 and Chip03, which have HyperTransport bus interfaces, on two PCBs in different planes, are connected through connector 1 and connector 2 respectively. The connectors cut across the HyperTransport buses respectively. The HyperTransport bus interfaces on the two PCBs connected through any one of the connectors are disposed on both sides of the one of the connectors respectively. As shown in FIG. 6, the processor Chip02 on PCB1 is connected to the processor Chip01 on PCB2 via the connector 1, and the connecting lines between the two processors Chip02 and Chip01 are connected sequentially to the connector 1 such that the intercrossing of signals on the HyperTransport bus between processor Chip02 and Chip01 can be avoided. Likewise, Chip03 on PCB1 and Chip00 on PCB2 are connected via the connector 2, and the connecting lines Chip03 and Chip00 are distributed sequentially. Such a connection structure is simple but effective, and can prevent lines distributed on the PCBs to intercross with each other. As a result, the signals on the HyperTransport buses can be transported reliably.

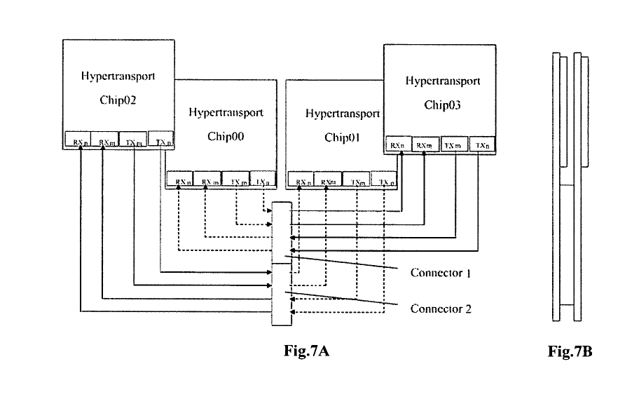

FIG. 7A and FIG. 7B are the front view and the side view of an interconnect structure between HyperTransport bus interface boards as shown in FIG. 6.

In FIG. 7A and FIG. 7B, processor Chip00 and processor Chip01 are disposed on the lower PCB2, and processor Chip02 and processor Chip03 are disposed on the upper PCB1; the dashed lines represent the signal lines on the lower PCB2, and the solid lines represent the signal lines on the upper PCB1; the bus interfaces of the processor Chip00 are interconnected with the processor Chip03, and the bus interfaces of the processor Chip01 are connected with the processor Chip02. The processor Chip02 on the upper PCB1 is connected with the processor Chip01 on the lower PCB2 via connector 1. The connecting lines between the two processors Chip02 and Chip01 are connected sequentially to the connector 1. Each of the processors has two transmit ports (T×m, T×n) and two receive ports (R×m, R×n). The transmit interface T×m (T×n) of one processor (Chip00••Chip01) is connected to the receive port R×m (R×n) of the other processor (Chip03••Chip02) via the corresponding connector. As a result, the intercrossing of connecting lines of the HyperTransport buses can be avoided. Likewise, Chip03 on PCB1 and Chip00 on PCB2 are connected via connector 2, and the connecting lines between Chip03 and Chip00 are distributed sequentially Therefore, this method may prevent the intercrossing between signals and the intercrossing between the connecting lines of the HyperTransport buses.

It is understood the examples and embodiments described herein are for illustrative purposes only and that various modifications or changes will be suggested to persons skilled in the art and are to be included within the spirit and purview of this application and scope of the appended claims

What is claimed is:

1. An interconnect structure between HyperTransport bus interface boards, for interconnecting corresponding HyperTransport bus interfaces disposed on different Printed Circuit Boards (PCBs) via a connector, wherein the connector cuts across a HyperTransport bus, and terminals of two HyperTransport bus interfaces on two different PCBs connected via the connector are connected with each other correspondingly via connecting lines sequentially distributed, to avoid the intercross of the HyperTransport buses.

2. The interconnect structure as in claim 1, wherein the structure comprises one or multiple said connectors disposed between the two different PCBs to connect the HyperTransport bus interfaces on the two different PCBs.

3. The interconnect structure as in claim 2, wherein the multiple connectors are disposed collinearly in a longitudinal direction of the connectors.

4. The interconnect structure as in claim 2, wherein the multiple connectors are disposed in parallel in a longitudinal direction of the connectors.

5. The interconnect structure as in claim 2, wherein the multiple connectors are disposed to be interleaved.

6. The interconnect structure as in claim 1, further comprising one or multiple pairs of the HyperTransport bus interfaces, wherein the one or multiple pairs of the HyperTransport bus interfaces are interconnected via one or multiple corresponding connectors.

7. The interconnect structure as in claim 6, wherein the multiple pairs of HyperTransport bus interfaces are disposed collinearly in an interface arrangement direction on the two PCBs respectively.

8. The interconnect structure as in claim 6, wherein the multiple pairs of HyperTransport bus interfaces are disposed in parallel in an interface arrangement direction on the two PCBs respectively.

9. The interconnect structure as in claim 6, wherein the multiple pairs of HyperTransport bus interfaces are disposed to be interleaved on the two PCBs respectively.

10. The interconnect structure as in claim 2, further comprising one or multiple pairs of the HyperTransport bus interfaces, wherein the one or multiple pairs of the HyperTransport bus interfaces are interconnected via one or multiple corresponding connectors.

11. The interconnect structure as in claim 10, wherein the multiple pairs of HyperTransport bus interfaces are disposed collinearly in an interface arrangement direction on the two PCBs respectively.

12. The interconnect structure as in claim 10, wherein the multiple pairs of HyperTransport bus interfaces are disposed in parallel in an interface arrangement direction on the two PCBs respectively.

13. The interconnect structure as in claim 10, wherein the multiple pairs of HyperTransport bus interfaces are disposed to be interleaved on the two PCBs respectively.

14. The interconnect structure as in claim 1, wherein the one or multiple connectors correspond to one or multiple pairs of the HyperTransport bus interfaces.
